(19) United States
(12) Patent Application Publication
(10) Pub. No.: US 2002/0080884 A1
(43) Pub. Date: Jun. 27, 2002

(54) Variable-rate QAM transceiver

(76) Inventors: Hoon Lee, Taejon (KR); Tae-Whan Yoo, Taejon (KR); Jong-Hyun Lee, Taejon (KR)

Correspondence Address: JACOBSON, PRICE, HOLMAN & STERN, PROFESSIONAL LIMITED LIABILITY COMPLANY, 400 Seventh Street, N.W., Washington, DC, 20004, US

(21) Appl. No.: 09/846,205

(22) Filed: May 2, 2001

(30) Foreign Application Priority Data
Dec. 27, 2000 (KR) 2000-83307

(51) Int. Cl. H04L 27/20

(52) U.S. Cl. 375/261; 375/298; 375/320; 329/304; 332/103

(57) ABSTRACT

A variable-rate QAM (Quadrature Amplitude Modulation) transceiver of the present invention facilitates data interfacing between a number of bands having different transmission rates by using a number of transmitters and receivers in downstream and upstream, respectively, to provide a symmetric service in which data transmission rate in upstream is equal to that in downstream even under environment of serious channel attenuation of a signal for high frequency. That is, the variable-rate QAM transceiver of the present invention comprises a number of transmitter blocks for providing various transmission rates to the transmitters and a number of receiver blocks for providing various transmission rates to the receivers, for properly adjusting bandwidth allocation of the passband signal bandwidth of a number of transmitters and receivers to enable high speed symmetric data transmission.

### FIELD OF THE INVENTION

The present invention relates to a transceiver of a digital communication system, and, more particularly, to a variable-rate QAM (Quadrature Amplitude Modulation) transceiver for facilitating data interfacing between a number of bands that have different transmission rates by using a number of transmitters and receivers in downstream and upstream, respectively, to provide a symmetric service in which data transmission rate in upstream is equal to that in downstream even under environment of serious channel attenuation of a signal for frequency.

### PRIOR ART OF THE INVENTION

FIG. 1 is a diagram of a conventional multi-level QAM (Quadrature Amplitude Modulation) transceiver.

At a TC (Transmission Convergence) sub-layer 100, data after preprocessing such as frame processing and FEC (Forward Error Correction) is symbol-encoded.

The symbol encoder 102 encodes inputted data to complex M-QAM (M-ary QAM) in forms of Aₙ=aₙ+j bₙ. The symbol-encoded quadratic multi-level data passes a square-root Nyquist filter 104 for pulse-shaping and an interpolator 106 for matching sampling rate to a D/A (digital to analog) converter 112.

The signal after the interpolator 106 is multiplied 110 with a carrier frequency that is generated at a DDFS (Direct Digital Frequency Synthesizer) 108 to be converted to a passband signal and, then, is converted to an analog signal at a D/A converter 112 to be transmitted to a transmission line.

Since sampling rate to symbol rate ratio is changed depending on interpolation ratio, symbol rate is variable when sampling rate is fixed.

On the other hand, a receiver acts in reverse of the transmitter. The signal received through the transmission line 114 is converted to a digital signal at an A/D converter 116 where the digital signal is multiplied 120 with a carrier frequency generated at a DDFS 118 to be converted to a baseband signal. The baseband signal goes through a decimator 122, a matched filter 124 and an equalizer 126 to compensate signal distortion through the transmission line. The output signal of the equalizer 126 is converted to a symbol at a QAM symbol decoder 128 and the symbol is sent to a TC sub-layer 130.

As shown in FIG. 1, the transceiver of the conventional digital communication system provides a transmitter and a receiver in upstream and downstream, respectively, but, generally, only supports a fixed data transmission speed.

Though there have been recently developed systems capable of varying data transmission rate in upstream and downstream, only low speed symmetric service and asymmetric service can be provided in serious attenuation channel environment such as telephone line because they provide only one transmitter and one receiver.

### SUMMARY OF THE INVENTION

Therefore, it is an object of the present invention to provide a variable-rate QAM (Quadrature Amplitude Modulation) transceiver for facilitating data interfacing between a number of bands having different transmission rates by using a number of transmitters and receivers in downstream and upstream, respectively, to provide a symmetric service in which data transmission rate in upstream is equal to that in downstream even under an environment of a serious channel.

That is, it is an object of the present invention to provide a variable-rate QAM transceiver comprising a number of transmitter blocks for providing various transmission rates to the transmitters and a number oL receiver blocks for providing various transmission rates to the receivers, for properly adjusting bandwidth allocation of the passband signals of a number of transmitters and receivers to enable high speed symmetric data transmission.

In accordance with an aspect of the present invention, there is provided a QAM transmitting apparatus having a multiplicity of transmission bands with variable transmission rates, comprising a TC (Transmission Convergence) sub-layer for performing frame processing and error correction for TX (transmitting) data; a band splitter for distributing the TX data preprocessed by the TC sub-layer to a predetermined number of band Tx processing units; the band TX processing units for symbol-encoding the output data of the band splitter, pulse-shaping and interpolating the symbol-encoded data, and converting the interpolated TX data to a passband signal; synthesizer for synthesizing the passband signal outputted from a predetermined number of the band TX processing unit; and a digital-to-analog converting and outputting unit for converting the synthesized digital TX data to an analog synthesized TX signal to output.

In accordance with another aspect of the present invention, there is provided a QAM receiving apparatus having a multiplicity of transmission bands with variable transmission rates, comprising an analog-to-digital converter for converting an analog signal received through a transmission line to a digital RX (receiving) signal; a band pass filter for distributing the digital RX signal to a predetermined number of band RX processing units; the band RX processing units for converting the RX signal distributed from the band pass filter to a baseband signal, compensating signal distortion of the baseband signal caused by the transmission line, and converting the compensated RX signal by QAM-decoding to a symbol; a band multiplexer for multiplexing the output data from the predetermined number of the band RX processing units; and a TC (Transmission Convergence) sub-layer for performing frame processing and error correction for the multiplexed RX data from the band multiplexer.

### BRIEF DESCRIPTION OF THE DRAWINGS

The above and other objects and features of the instant invention will become apparent from the following description of embodiments taken in conjunction with the accompanying drawings, in which:

FIG. 1 is a diagram of a conventional multi-level QAM transceiver;

FIG. 2 offers a diagram of one embodiment of a 4-band multi-level QAM transceiver in accordance with the present invention;

FIG. 3 provides a diagram of one embodiment of a band splitter/band mux in accordance with the present invention; and

FIG. 4 is a diagram for explaining a band slitter in accordance with the present invention.

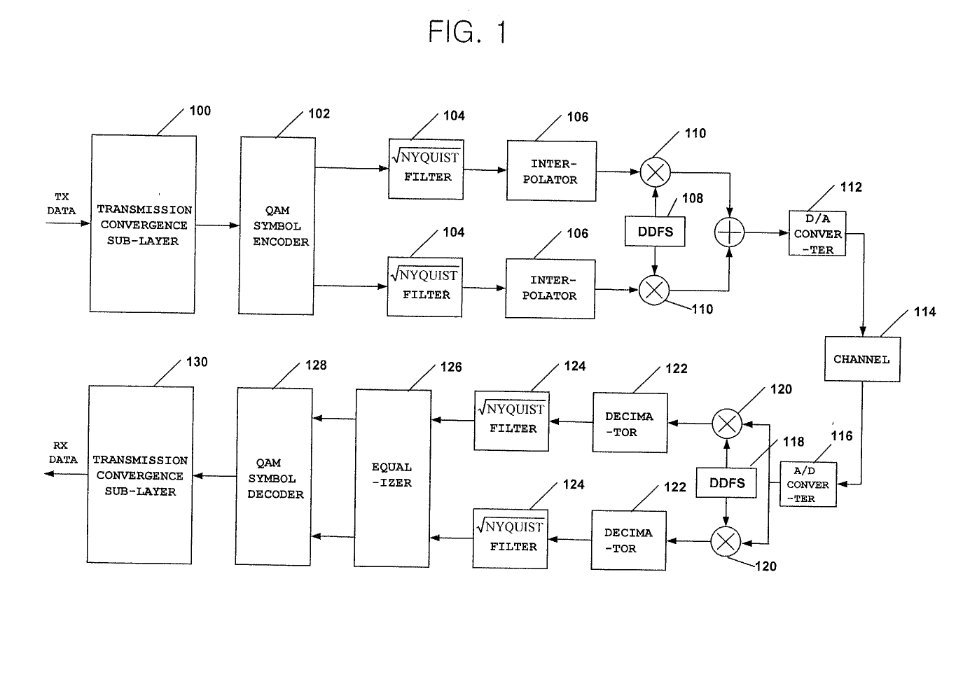

### PREFERRED EMBODIMENT OF THE INVENTION

The present invention relates to a 4-band QAM (Qaudrature Amplitude Modulation) transceiver capable of symmetric data transmission and supports variable transmission rate.

In general, a QAM transceiver comprises a transmitter and a receiver, each supporting one transmission band.

When data is transmitted through a telephone line, it is difficult to match transmission rate of the transmitter and the receiver because high frequency band attenuation is very serious.

In the present invention, both of the transmitter and the receiver have two transmission bands to enable symmetric data transmission in suffering environment and each of the two bands can support various transmission rates.

Therefore, the present invention is capable of providing various transmission rates, high speed symmetric data transmission, and efficiently interfacing between four different transmission bands, each supporting different transmission rates.

In other words, the present invention facilitates data interfacing between a number of bands having different transmission rates by using a number of transmitters and receivers in downstream and upstream, respectively, to provide a symmetric service in which data transmission rate in upstream is equal to that in downstream even under environment of serious channel attenuation for high frequency.

The downstream is a data transmission path from a transmitter at network side to a receiver at user side and the upstream is another data transmission path in reverse to the downstream.

The present invention enables high speed symmetric data transmission by providing various transmission rates to the transmitters and a number of receiver blocks for providing various transmission rates to the receivers, for properly adjusting bandwidth allocation of the passband of a number of transmitters and receivers.

Both of the transmitter and the receiver have a TC (Transmission Convergence) sub-layer for frame processing, OAM (Operation And Maintenance) and FEC (Forward Error Correction) Therefore, two pairs of the transmitters or the receivers that can support different transmission rates should be interfaced with the TC.

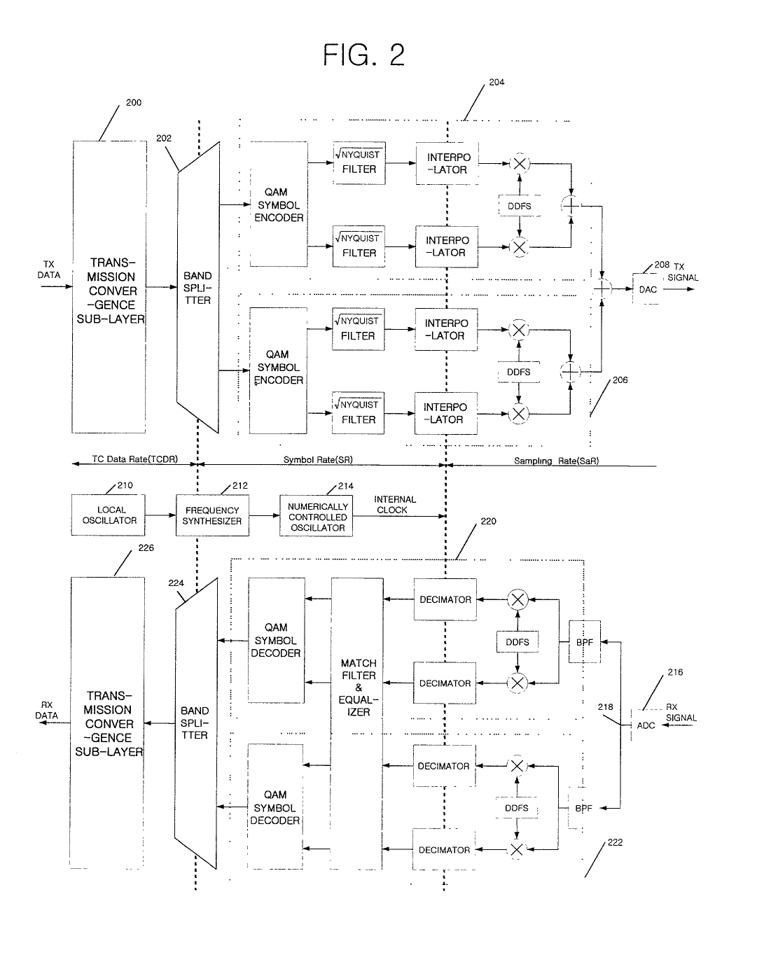

Also, the different rates of the two pairs of the transmitter or the receiver should be matched with the sampling rate of a D/A (Digital-to-Analog) converter referring to FIG. 2. This matching is required inevitably in the present invention that use two transmitters and two receivers.

Hereinafter, preferred embodiments of the present invention and measurement results will be described in detail with reference to the accompanying drawings.

FIG. 2 offers a diagram of one embodiment of a 4-band multi-level QAM transceiver in accordance with the present invention.

The transmitter block and the receiver block of the 4-band multi-level QAM transceiver have two transmitters and two receivers, respectively, and each block requires three clocks of a TC clock, a symbol clock and a sampling clock.

As shown in FIG. 2, the transmitter of the receiver block of the 4-band QAM transceiver (2 bands for the transmitter block and 2 bands for the receiver block) in which two transmitters 204, 206 supporting different transmission rates are interface with a TC sub-layer 200.

Therefore, in order to interface two transmitters 204, 206 of different transmission rates to the TC sub-layer 200, the data transmission rate DRTC of the TC sub-layer 200 should be sum of the data transmission rates DR_{TX1} and DR_{TX2} of the transmitters.

DR_{TC}=DR_{TX1}+DR_{TX2} Eq.(1)

Since DR_{TX1} and DR_{TX2} are selected from integers or non-integers, the DRTC is not integer times of DR_{TX1} nor DR_{TX2}.

Therefore, three independent clocks are required and three independent PLLs (Phase Locked Loops) are sometimes required.

Especially, when the system clock is produced from the symbol clock recovered from an input signal of a band 1 or a band 2, the PLL is inevitably required for the receiver of the 4-band transceiver.

Relation between the symbol clock and the sampling clock is not integer times as for the TC clock. Therefore, since four independent clocks are required for the 4-band transmitters in FIG. 2 and another four independent clocks for the 4-band receivers, 8 independent clocks are required as a whole.

When the clocks are generated by the PLLs, chip size and power consumption increase to be inefficient.

As shown in FIG. 2, when the clock is supplied from the network, a system clock of a high speed is internally produced from a reference clock that is received from the network. The system clock is applied to a NCO (Numerically Controlled Oscillator) 214 where required clocks are produced.

In this case, when clock rate of the symbol clock or the sampling clock is changed, only the NCO should be adjusted. For example, if a NCO input clock is 100 MHz and a control register of the NCO consists of 10 bits, the NCO is capable of producing clocks in unit of 97656 Hz (100 MHz/2¹⁰).

If the clock is not supplied from the network, the clock that is supplied from an external crystal oscillator or recovered from a received signal of the receiver block is used. In this case, the clock produced by the NCO includes jitter and the system clock should be high speed to reduce the jitter.

In the present invention, in order to reduce the number of the independent clocks, it is possible to use a method for selecting LCM (Least Common Multiplier) of the transmission rates of the band 1 transmitter and the band 2 transmitter as the rate of the sampling clock. By doing this, the transmission rates of the band 1 transmitter and the band 2 transmitter can be 1/N₁ times and 1/N₂ times of the sampling clock, respectively.

It will be described in detail for operation of the transceiver in FIG. 2. Firstly, transmitting procedure will be described.

The TC sub-layer 200 performs frame processing and error correction for inputted TX data and a band splitter 202 distributes the TX data that are processed by the TC sub-layer 200 to a number of band transmitters 204, 206 in unit of byte, matching transmission rate of the bands transmitters 204, 206.

In the band transmitters 204, 206, a QAM symbol encoder performs symbol-encoding for the output data of the band splitter 202, a square root Nyquist filter performs pulse-shaping for the symbol-encoded data, an interpolator interpolates the output of the square root Nyquist filter.

Then the interpolated TX data is converted to a passband signal.

That is, the symbol encoder encodes the inputted data to a complex M-QAM (M-ary QAM) of Aₙ=aₙ+j bₙ. The symbol-encoded quadratic multi-level data is pulse-shaped at the square root Nyquist filter, interpolated at the interpolator, and then interfaced with the sampling rate of the D/A converter 112. The signal passing through the interpolator is multiplied with a carrier frequency that is generated at a DDFS (Direct Digital Frequency Synthesizer) to be converted to the passband signal.

The synthesizer 207 synthesizes the passband signal from the band transmitters 204, 206 and the D/A converter 208 converts the digital synthesized transmitting data to an analog synthesized transmitting signal that is transmitted through a transmission line not shown.

On the other hand, it will be described for the receiving procedure.

An A/D converter 216 is converted to an analog signal that is received through the transmission line to a digital receiving signal distributor 218 and the distributor 218 distributes the converted digital signal to the band receivers 220, 222.

In the band receivers 220, 222, the distributed signal is converted to a baseband signal whose signal distortion caused by the transmission line is compensated and the compensated received signal is QAM-decoded to a symbol.

That is, the signal that is received through the transmission line is converted to the digital signal at the A/D converter 216 and multiplied with the carrier frequency that is generated at the DDFS to be converted to the baseband signal whose signal distortion is compensated by an equalizer. Here, The signal distortion is caused by the transmission line. The output signal of the equalizer is decoded in unit of byte at a QAM symbol decoder to be converted to the symbol.

The band Mux 224 multiplexes the output data from the band receivers 220, 222 in unit of byte, matching the transmission rates of the band receivers 220, 222. The TC sub-layer 226 performs frame processing and error correction for the multiplexed received data from the band Mux 224.

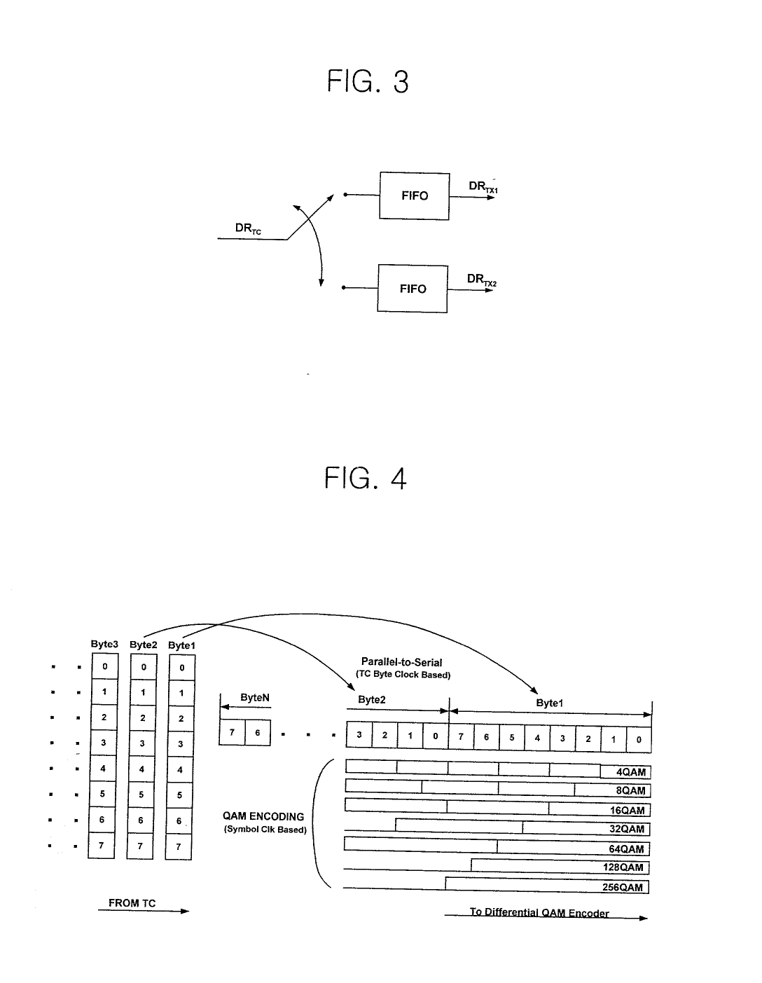

FIG. 3 provides a diagram of one embodiment of a band splitter and a band Mux (multiplexer) in accordance with the present invention.

The present invention introduces a scheme as shown in FIG. 4 in order to implement efficiently a band slitter 202 for distributing the TC data to the band 1 transmitter and the band 2 transmitter and a band multiplexer.

Firstly, it will be described for the operation of the band splitter 202 in FIG. 3.

The band splitter 202 distributes the TC output data to the symbol encoders of the band 1 transmitter and the band 2 transmitter with the transmission rates, respectively.

For example, when the transmission rates of the TC data, the band 1 transmitter and the band 2 transmitter are 3, 1 and 2, respectively, the band splitter distributes a first data to the band 1 and a second data and a third data to the band 2. Also, in order to prevent data loss, FIFOs should be prepared between the TC and each of the transmitters and the FIFOs respectively operate in synchronization with three separate clocks.

When interfaces between the TC sub-layer 200 and each of the band 1 and band 2 transmitters 204, 206 are processed in unit of bit, the basic processing unit of the TC sub-layer is byte. Regarding the QAM symbol encoder transforms m bit data to 2^{m} symbols, dual transformation from the byte data of the TC sub-layer to the bit data and from the bit data stream to the 2^{m} symbols is required. Tnerefore, various bit clocks of different rates are required.

FIG. 4 is a diagram for explaining a band slitter of the present invention.

In the present invention, the number of the hardware and the clocks are reduced by directly encoding the byte data of the TC to the 2^{m} symbols.

In FIG. 4, the interfaces between the TC and the band 1 transmitter as shown in FIG. 3 is shown in detail, in which data distributed from the TC are inputted through the FIFO in unit of byte.

For M-QAM(M=2^{m}), first LSB m bits of the inputted byte data are mapped to one symbol. For example, for 4-QAM, first two bits are mapped to one of 2²=4 symbols. Therefore, separate bit transformation can be omitted by symbol encoding in unit of m bits from the LSB of the inputted byte data.

Since symbol encoding is not executed by one byte input properly when m is not GCD (Greatest Common Divider) of 8, i.e., m is one of 3, 5, 7 and 9, the continuously inputted byte data should be circulated virtually to encode continuously. In this case, the input byte and the symbol encoding are synchronized in unit of 8 at maximum.

In FIG. 4, various QAMs only from 4 QAM to 256 QAM are shown since M is generally 256 (=28) at maximum in the multilevel M-QAM. But the present invention can be applied to other QAM, e.g., 512 QAM, 1024 QAM.

For the receiver, the band multiplexer that acts in reverse to the band splitter is required, which can be implemented as the band splitter.

As described above, in the channel environment where channel attenuation is severe as increasing the frequency, the present invention provides the 4-band transceiver capable of enabling variable rate for high speed symmetric data transmission.

That is, in the channel environment where channel attenuation is severe as increasing the frequency, the symmetric service in which data transmission rates in upstream is equal to that in downstream.

Also, the present invention provides the variable rate 4-band transceiver with various independent clocks by a PLL and a number of NCOs.

Furthermore, the present invention implements the band splitter for distributing the TC sub-layer data to two transmitters of different transmission rates and the band multiplexer for acting in reverse to the band splitter in unit of byte without complex hardware.

While the present invention has been shown and described with respect to the particular embodiments, it will be apparent to those skilled in the art that many changes and modifications may be made without departing from the spirit and scope of the invention as defined in the appended claims.

What is claimed is:

1. A QAM (Quadrature Amplitude Modulation) transmitting apparatus having a multiplicity of transmission bands with variable transmission rates, comprising:
TC (Transmission Convergence) sub-layer means for performing frame processing and error correction for TX (transmitting) data;
band splitting means for distributing the TX data preprocessed by the TC sub-layer means to a predetermined number of band Tx processing means;
the band TX processing means for symbol-encoding the output data of the band splitting means, pulse-shaping and interpolating the symbol-encoded data, and converting the interpolated TX data to a passband signal;
synthesizing means for synthesizing the passband signal outputted from a predetermined number of the band TX processing means; and
digital-to-analog converting and outputting means for converting the synthesized digital TX data to an analog synthesized TX signal to output.

2. The QAM transmitting apparatus as recited in claim 1, wherein data transmission rate of the TC sub-layer means is equal to sum of data transmission rates of the band TX processing means.

3. The QAM transmitting apparatus as recited in claim 1, wherein the band splitting means distributes the TX data matching transmission rate to each of the band TX processing means.

4. The QAM transmitting apparatus as recited in claim 1, wherein the band splitting means distributes the TX data to each of the band TX processing means in unit of byte.

5. The QAM transmitting apparatus as recited in claim 1, wherein the band TX processing means encodes the TX data in unit of byte.

6. A QAM (Quadrature Amplitude Modulation) receiving apparatus having a multiplicity of transmission bands with variable transmission rates, comprising:
analog-to-digital converting means for converting an analog signal received through a transmission line to a digital RX (receiving) signal;
band distributing means Lor distributing the digital RX signal to a predetermined number of band RX processing means;
the band RX processing means for converting the RX signal distributed from the band distributing means to a baseband signal, compensating signal distortion of the baseband signal caused by the transmission line, and converting the compensated RX signal by QAM-decoding to a symbol;
band multiplexing means for multiplexing the output data from the predetermined number of the band RX processing means; and
TC (Transmission Convergence) sub-layer means for performing frame processing and error correction for the multiplexed RX data from the band multiplexing means.

7. The QAM receiving apparatus as recited in claim 6, wherein the band multiplexing means multiplexes the RX data to each of the band RX processing means with matching transmission rate.

8. The QAM receiving apparatus as recited in claim 6, wherein the band multiplexing means distributes the RX data to the TC sub-layer means in unit of byte.

9. The QAM receiving apparatus as recited in claim 6, wherein the band RX processing means encodes the RX data in unit of byte.
